(19) United States
(12) Patent Application Publication
(10) Pub. No.: US 2026/0151986 A1
(43) Pub. Date: Jun. 4, 2026

(54) COMPOSITE PAD

(71) Applicant: INNOX ADVANCED MATERIALS CO., LTD., Asan-si (KR)

(72) Inventors: Hong Jeong Yu, Asan-si (KR); Sung Ju Yoo, Asan-si (KR); Duckhyun Song, Asan-si (KR); Kidae Kwon, Asan-si (KR)

(21) Appl. No.: 19/403,191

(22) Filed: Nov. 27, 2025

(30) Foreign Application Priority Data
Nov. 29, 2024 (KR) 10-2024-0175895

(51) Int. Cl. B32B 7/027; B32B 5/18; B32B 7/12; B32B 25/08; B32B 25/20; B32B 27/20; H01M 10/658

(52) U.S. Cl. CPC B32B 7/027; B32B 5/18; B32B 7/12; B32B 25/08; B32B 25/20; B32B 27/20; H01M 10/658; B32B 2264/102; B32B 2264/303; B32B 2266/0207; B32B 2307/3065; B32B 2307/536; B32B 2307/7376; B32B 2457/10

(57) ABSTRACT

A composite pad including: a silicone foam; an adhesive layer; and an outer layer, in which the adhesive layer includes a binder and a reactive filler that undergoes a dehydration reaction at a temperature equal to or higher than 100° C., the binder has a hardness in a range of a penetration hardness of 90 to a Shore 00 hardness of 40, the reactive filler is included in an amount of 50 to 300 parts by weight based on 100 parts by weight of the binder, and a thickness of the adhesive layer is in a range of 40 μm to 400 μm.

### CROSS-REFERENCE TO RELATED APPLICATION

This application claims priority from and the benefit of Korean Patent Application No. 10-2024-0175895, filed on Nov. 29, 2024, which is hereby incorporated by reference for all purposes as if fully set forth herein.

### BACKGROUND

### Field

Embodiments of the invention relate generally to a composite pad comprising an adhesive layer that absorbs heat and has fire extinguishing and heat blocking performance.

### Discussion of the Background

Recently, demand has been increasing for eco-friendly vehicles, such as an electric vehicle and a fuel cell vehicle that do not emit exhaust gas. Such eco-friendly vehicles are equipped with a motor for traveling and a battery for operating the motor. In a battery pack applied to these eco-friendly vehicles, multiple battery cells are stacked, and a surface-pressure pad capable of buffering in response to pressure is disposed between adjacent two battery cells.

The battery pack configured as described above is susceptible to thermal runaway, in which temperature continuously rises during use due to factors such as manufacturing defects, improper handling or misuse of the battery, or short-circuits within some battery cells, or the like. Thermal runaway may also occur when a battery cell is rapidly heated due to exposure to external heat or flame. In addition, because a plurality of battery cells are stacked in close contact with each other, thermal runaway can quickly propagate to adjacent battery cells within a short time period, which may lead to a disaster such as ignition or explosion.

Accordingly, in order to prevent thermal runaway under such conditions, improved fire resistance and heat dissipation characteristics are required.

Although a silicon foam is included in the surface-pressure pad, there is a problem that the silicon foam is decomposed without maintaining a thermal insulation performance in a high temperature environment equal to or higher than 400° C., due to its inherent heat resistance. Thus, an outer layer such as a fire resistant layer or a heat dissipation layer is sometimes additionally deposited on the silicon foam to address this issue.

However, depositing such an outer layer such as the fire resistant layer on the silicon foam typically employs an adhesive layer therebetween. Because most adhesive layers are formed of organic materials, their ability to prevent thermal runaway in the event of fire may be limited.

The above information disclosed in this Background section is only for understanding of the background of the inventive concepts, and, therefore, it may contain information that does not constitute prior art.

### SUMMARY

A composite pad according to an embodiment of the invention includes an adhesive layer that is capable of absorbing heat and having fire extinguishing and heat blocking performance.

Additional features of the inventive concepts will be set forth in the description which follows, and in part will be apparent from the description, or may be learned by practice of the inventive concepts.

According to an embodiment of the invention a composite pad includes: a silicone foam; an adhesive layer; and an outer layer, wherein the adhesive layer comprises a binder and a reactive filler that undergoes a dehydration reaction at a temperature equal to or higher than 100° C., in which the binder has a hardness in a range of a penetration hardness of 90 to a Shore 00 hardness of 40, the reactive filler is included in an amount of 50 to 300 parts by weight based on 100 parts by weight of the binder, and a thickness of the adhesive layer is in a range of 40 μm to 400 μm.

The binder may include at least one resin selected from a group consisting of a polyurethane-based resin, a silicone-based resin, and an epoxy-based resin.

A viscosity of the binder may be in a range of 100 cP to 2000 cP at 25° C.

The reactive filler may be metal hydroxide particles.

The metal hydroxide particles may include at least one selected from a group consisting of B(OH)₃, Al(OH)₃, Mg(OH)₂, and combinations thereof.

The reactive filler may include a mixture of first metal hydroxide particles having a D50 equal to or smaller than 2 μm and second metal hydroxide particles having a D50 equal to or greater than 5 μm.

The silicone foam may be a foamed cured product of a composition including a polyalkylsiloxane-based resin.

The outer layer may include at least one layer selected from a group consisting of a fire resistant layer, a flame retardant layer, an electrically insulating layer, a heat dissipation layer, and combinations thereof.

The composite pad may be positioned between battery cells.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 schematic view illustrating a composite pad according to an embodiment of the present disclosure.

FIG. 2 schematic view illustrating a composite pad according to another embodiment of the present disclosure.

FIG. 3 is a schematic diagram of a heat transfer delay test of Experimental Example 4.

FIG. 4 is a schematic diagram illustrating a composite pad disposed between battery cells.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a composite pad according to some embodiments of the present disclosure will be described.

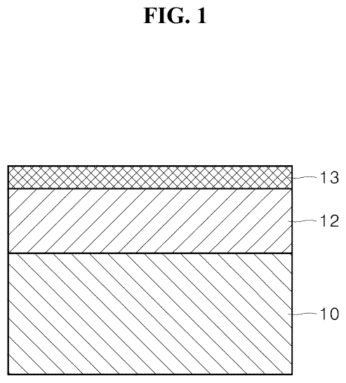

As illustrated in FIG. 1, a composite pad according to an embodiment of the present disclosure comprises a silicone foam, an adhesive layer, and an outer layer. The adhesive layer may exhibit excellent adhesion between the silicone foam and the outer layer, absorb heat, and exhibit fire extinguishing and heat blocking performance. At the same time, the adhesive layer may prevent thermal runaway by delaying heat transfer when exposed to high temperature. Hereinafter, the elements will be described in detail.

### Adhesive Layer

The composite pad according to an embodiment the present disclosure comprises the adhesive layer between the silicone foam and the outer layer, thereby exhibiting the excellent adhesion.

In general, because most adhesive layers comprise an organic material, the organic material may act as a hindrance factor in preventing the thermal runaway in the event of fire. On the other hand, the adhesive layer may exhibit excellent heat resistance and thus exhibit the excellent adhesion even at the high temperature. Accordingly, a phenomenon in which a portion of the composite pad is detached and spreads the fire when the composite pad is exposed to the high temperature may be prevented. In addition, the thermal runaway may be prevented by delaying heat diffusion.

The adhesive layer is a cured product of an adhesive composition comprising a binder and a reactive filler that undergoes a dehydration reaction at 100° C. or higher, and thus the adhesive layer comprises the binder and the reactive filler that undergoes the dehydration reaction at 100° C. Here, the term “reactive” may refer to both chemical reactivity, which involves breaking an existing chemical bond or forming a new chemical bond, and physical reactivity.

Specifically, the reactive filler undergoes the dehydration reaction at 100° C. or higher, and may not react during normal operation of a battery, but generates water (H₂O) when exposed to an abnormally high temperature environment to perform the fire extinguishing or the heat blocking. Here, “water (H₂O)” includes liquid water, water vapor, or a combination thereof. Further, the generated water may additionally absorb heat while evaporating. Accordingly, spread of heat to the silicone foam or an adjacent battery cell may be prevented, thereby preventing the thermal runaway from occurring in the battery.

For example, when a reactive filler that undergoes the dehydration reaction at a temperature lower than 100° C. is included, moisture in the liquid form can easily be generated from the adhesive layer, which may result in deterioration of the adhesion. In addition, components such as an electrode or the like included in the battery may be oxidized or discolored. Further, when the moisture is subsequently exposed to the high temperature, the moisture may be vaporized into water vapor and expand in volume, thereby increasing a possibility of breakage of an adhesive layer surface. Furthermore, fire resistance may be deteriorated, and thus the heat transfer delay effect may be deteriorated.

The reactive filler may be metal hydroxide particles. For example, the metal hydroxide particles may comprise at least one selected from a group consisting of B(OH)₃, Al(OH)₃, Mg(OH)₂, and combinations thereof.

The adhesive layer may comprise two or more metal hydroxides. In this case, a difference in thermal decomposition temperature between a first metal hydroxide and a second metal hydroxide may be in a range of 50° C. to 150° C. Accordingly, in a situation in which the temperature of the battery increases, the metal hydroxides may sequentially exhibit reactivity to more efficiently prevent the heat diffusion phenomenon, but the inventive concepts are not limited thereto.

The adhesive layer may comprise the two or more metal hydroxides. For example, the adhesive layer may comprise, as the reactive filler, a mixture of first metal hydroxide particles having a D50 equal to or smaller than 2 μm and second metal hydroxide particles having a D50 equal to or greater than 5 μm, but the inventive concepts are not limited thereto. For example, the D50 of the first metal hydroxide particles may be in a range of 0.3 μm to 2 μm, and the D50 of the second metal hydroxide particles may be in a range of 5 μm to 40 μm, without being limited thereto.

The reactive filler is comprised in an amount of 50 to 300 parts by weight based on 100 parts by weight of a binder. Accordingly, while sufficiently absorbing heat well and preventing the thermal runaway from occurring, the excellent adhesion may be maintained. For example, when the content of the reactive filler is less than 50 parts by weight, the adhesive layer is substantially affected by characteristics of the binder, so that the characteristics of the adhesive layer may be weakened, the heat resistance may be lowered, and thus the adhesion may be deteriorated when exposed to the high temperature for a long time. In addition, the heat transfer delay effect may be low and thus sufficient fire resistance may not be exhibited. Furthermore, when the content of the reactive filler exceeds 300 parts by weight, the adhesion may be deteriorated due to lack of compatibility with an organic binder and an insufficient contact surface area.

The adhesive layer comprises the binder. The reactive filler may be dispersed in the binder. The binder has a hardness in a range of a penetration hardness of 90 to a Shore 00 hardness of 40. Accordingly, the excellent heat resistance and the excellent heat diffusion prevention effect may be exhibited, and simultaneously, the excellent adhesion may be exhibited by physical and chemical reaction with the reactive filler.

Specifically, as described above, the reactive filler dispersed in the binder may generate water by the dehydration reaction, and simultaneously absorb heat along with the fire distinguishing while vaporizing the water, thereby delaying the heat transfer. In this regard, the vaporized water vapor may lower the temperature while permeating through the adhesive layer, and it was discovered that this phenomenon can vary depending on the hardness of the binder.

In general, a hardness measurement method varies depending on an object whose hardness to be measured. Specifically, a hardness of a soft material may be determined using the penetration hardness, and the penetration hardness may be measured according to ASTM D217. In addition, Shore 00 hardness is used to measure a hardness of a somewhat harder material than the material whose hardness is determined using the penetration hardness, and the Shore 00 hardness may be measured according to ASTM D 2240.

The binder has the hardness in the range of the penetration hardness of 90 to the Shore 00 hardness of 40, and may allow water generated from the reactive filler to be vaporized into water vapor and to permeate through the adhesive layer well. Accordingly, heat may be lowered and the heat diffusion may be well delayed. At the same time, the excellent adhesion may be exhibited. For example, when the hardness of the binder is lower than the penetration of 90, a curing density of the binder itself may be low, and the reactive filler may be easily separated due to an insufficient force of bonding with the reactive filler. On the other hand, when the hardness of the binder is higher than the Shore 00 hardness of 40, the heat diffusion may not be delayed, and when the binder is bonded with the reactive filler, the bonding force therebetween may be significantly low, and thus the adhesive layer may fail and be delaminated.

The binder may comprise at least one resin selected from a group consisting of a polyurethane-based resin, a silicone-based resin, and an epoxy-based resin. For example, the binder may be the silicone-based resin.

The binder may have a viscosity in a range of 100 cP to 2000 cP at 25° C. Accordingly, excellent coatability and excellent adhesion and durability may be exhibited while the reactive filler is comprised in the adhesive layer, but the inventive concepts are not limited thereto.

The adhesive composition may further comprise an additive such as a silane coupling agent. The adhesive composition may exhibit a viscosity equal to or lower than 50,000 cP at 25° C. In an embodiment, the adhesive composition may exhibit a viscosity of 48,000 cP, but the inventive concepts are not limited thereto.

A thickness of the adhesive layer is in a range of 40 μm to 400 μm. The adhesive layer has the thickness within the above range, thereby well delaying the heat transfer and preventing the thermal runaway.

The adhesive layer may exhibit an adhesion equal to or greater than 90 gf/cm. In addition, because of the excellent heat resistance thereof, the adhesion equal to or greater than 90 gf/cm may be exhibited even when the adhesive layer is exposed at a high temperature of 200° C. for 12 hours. For example, the adhesive layer may exhibit an adhesion equal to or greater than 100 gf/cm or equal to or greater than 110 gf/cm but the inventive concepts are not limited thereto.

### Silicone Foam

The composite pad comprises the silicone foam to which the adhesive layer is attached. The silicone foam may be used without limitation as long as it is used as a surface-pressure pad in the battery.

For example, the silicone foam may be a foam formed by hydrogen gas generated by a dehydrosilylation reaction. The silicone foam may be a foamed cured product of a composition comprising a polyalkylsiloxane-based resin. The polyalkylsiloxane-based resin may be formed from a silicone resin composition forming a matrix of the foam. The silicone resin composition is not particularly limited as long as it is a composition that satisfies thermal conductivity, tensile strength, elongation, and/or glass transition temperature (Tg) of the silicone foam.

For example, the silicone resin composition may comprise a polydialkylsiloxane (A), a vinyl alkyl MQ siloxane resin (B), and a poly(alkylhydrogen)siloxane (C), each having a vinyl group at an end thereof, and a polydialkylsiloxane (D) and an alcohol (E), each having a hydroxyl group at an end thereof.

More specifically, the polydialkylsiloxane (A) having the vinyl group at the end thereof may be a main silicon resin comprised in the resin composition, and may be an MDM-structured compound, in which a main chain comprises repeating units of the dialkylsiloxane (D) and both ends thereof are capped with a monomer (M) having the vinyl group. The polydialkylsiloxane (A) having the vinyl group at the end thereof may impart softness to the silicone foam. The polydialkylsiloxane (A) having the vinyl group at the end thereof may be a mixture of two types of materials having different viscosities. For example, the polydialkylsiloxane (A) having the vinyl group at the end thereof may be a mixture of a polydialkylsiloxane (A-1) having the vinyl group at a first end and having a viscosity in a range of 100 cP to 1,000 cP at 25° C. and a polydialkylsiloxane (A-2) having the vinyl group at a second end and having a viscosity equal to or greater than 5,000 cP and smaller than 100,000 cP. In an embodiment, the polydialkylsiloxane (A) having the vinyl group at the end thereof may not comprise a material having a viscosity equal to or greater than 100,000 cP. The polydialkylsiloxane (A) having the vinyl group at the end thereof may be comprised in an amount of 10 to 80 parts by weight based on 100 parts by weight of the silicone resin composition. Further, the polydialkyl siloxane (A) having the vinyl group at the end thereof may not be particularly limited as long as it is generally used in the art, but may comprise, for example, a polydialkyl siloxane having an alkyl group with 1 to 6 carbon atoms. For example, it may be a polydimethylsiloxane end-treated with the vinyl group.

In addition, the vinyl alkyl MQ siloxane resin (B) is a polymer of a silicon resin having a three-dimensional structure composed of M units [(CH₂CH)(CH₃)₂SiO_{1/2}] and Q units [SiO₄/2], and may impart hardness and toughness to the silicon foam. The vinyl alkyl MQ siloxane resin (B) may have a weight-average molecular weight in a range of 1,000 g/mol to 8,000 g/mol. The vinyl alkyl MQ siloxane resin (B) may be comprised in an amount of 0.5 to 15 parts by weight based on 100 parts by weight of the silicone resin composition. For example, the vinyl alkyl MQ siloxane resin (B) may be a vinyl methyl MQ silicone resin.

The poly(alkylhydrogen) siloxane (C), as a curing agent that reacts with the vinyl group of the (A) or the vinyl group of the (B), may be comprised in an amount of 0.1 to 10 parts by weight based on 100 parts by weight of the silicone resin composition. The poly(alkylhydrogen) siloxane (C) may be a material having a viscosity in a range of 60 cP to 1,000 cP at 25° C. For example, the (C) may be a poly(methylhydrogen)siloxane.

The polydialkylsiloxane (D) having the hydroxyl group at the end thereof may react with hydrogen of the (C), which is the curing agent, to generate hydrogen gas (H2) and form a foam, and may be comprised in an amount of 5 to 20 parts by weight based on 100 parts by weight of the silicone resin composition. The polydialkylsiloxane (D) having the hydroxyl group at the end thereof may be comprised in the amount within the above range, thereby affecting a tensile strength and an elongation of the silicone foam. The polydialkylsiloxane (D) having the hydroxyl group at the end thereof may be a material having a viscosity in a range of 10 cP to 100 cP at 25° C. For example, the (D) may be a polydimethylsiloxane end-treated with the hydroxyl group.

The alcohol (E) may react with the hydrogen of the (C), which is the curing agent, together with the (D) to generate hydrogen gas (H2) and form the foam. A monomolecular material may be used as the alcohol, so that the reaction may proceed faster than with the (D), thereby affecting a foaming rate. For example, the alcohol may be methanol or ethanol having a small molecular weight. In an embodiment, the alcohol may be ethanol. Because the (E) has poor compatibility with silicon, in an embodiment, the (E) may be used in a small amount. For example, the alcohol (E) may be comprised in an amount of smaller than 1 part by weight, for example, greater than 0 part by weight and smaller than 1 part by weight, based on 100 parts by weight of the silicone resin composition.

### Outer Layer

The composite pad comprises the outer layer on an opposite surface of the adhesive layer. Thus, the excellent fire resistance and heat dissipation characteristics are exhibited in an environment with a temperature significantly exceeding the heat resistance of the silicone foam, thereby preventing the occurrence of the thermal runaway.

The outer layer, as a layer positioned outwardly of the silicon foam, may comprise at least one layer selected from a group consisting of a fire resistant layer, a flame retardant layer, an electrically insulating layer, a heat dissipation layer, and combinations thereof.

Specifically, the fire resistant layer or the flame retardant layer, as a layer that directly blocks the flame, may comprise a heat-resistant polymer containing mica, silica, carbon fiber, and glass fiber.

The electrically insulating layer, as a layer that secures electrical insulation between the battery cells and between positive and negative electrodes during the battery operation, may comprise polyimide (PI), polyethylene terephthalate (PET), silicone, an acryl-based polymer, a urethane-based polymer, or the like.

The heat dissipation layer, as a layer that anisotropically dissipates heat through heat diffusion, may comprise graphite, graphene, a composite of thermally conductive inorganic particles and polymers, and the like.

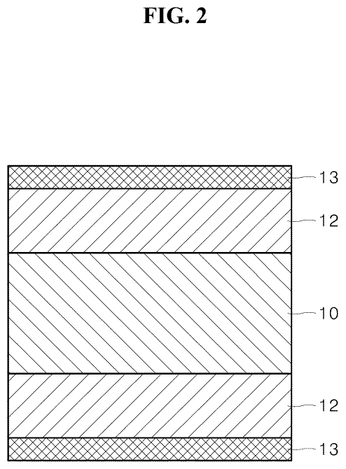

As illustrated in FIG. 2, the composite pad may have a sandwich structure in which the adhesive layers are respectively attached to both surfaces of the silicone foam and each outer layer is deposited on each adhesive layer.

The composite pad may exhibit a thermal delay duration equal to or longer than 60 seconds in a thermal transfer delay test to be described later. For example, the thermal delay duration may be equal to or longer than 80 seconds or equal to or longer than 100 seconds, but the inventive concepts are not limited thereto.

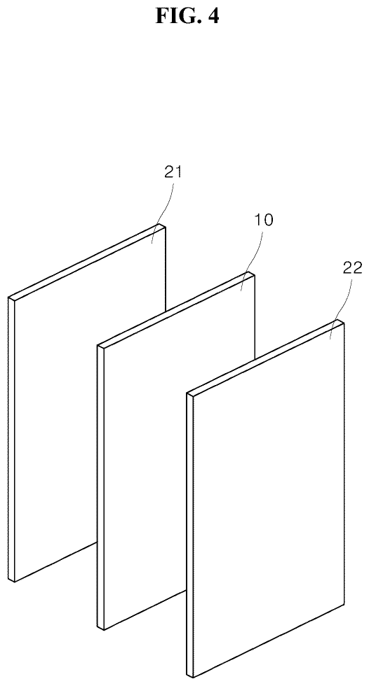

As illustrated in FIG. 4, the composite pad may be positioned between the battery cells. Specifically, the composite pad 10 may be disposed between battery cells 21 and 22. Accordingly, the composite pad 10 may exhibit a buffering function and the thermal runaway prevention function with the excellent adhesion.

### PRESENT EXAMPLES

### Present Example 1

An adhesive composition comprising 60 parts by weight of a binder A-1, 40 parts by weight of a reactive filler B-1, and 0.9 parts by weight of a silane coupling agent ((3-glycidoxypropyl)trimethoxysilane, CAS 2530-83-8) was prepared.

Then, the adhesive composition was applied to each of both surfaces of a silicone foam having a thickness of 2,000 μm, and a fire resistant layer comprising mica having a thickness of 100 μm was deposited thereon. Thereafter, the adhesive composition was cured to prepare a composite pad comprising an adhesive layer having a thickness of 300 μm.

### Present Examples 2 to 9 and Comparative Examples 1 to 5

By changing the binder and the reactive filler in Present Example 1 as illustrated in Table 1 to 3, adhesive compositions of Present Examples 2 to 9 and Comparative Examples 1 to 5 were prepared.

In addition, by changing the thicknesses of the silicon foam, the adhesive layer, and the outer layer (the fire resistant layer) as illustrated in Table 7 to 9, composite pads of Present Examples 2 to 9 and Comparative Examples 1 to 5 were prepared.

TABLE 1

| | | Present | Present | Present | Present | Present |
|---|---|---|---|---|---|---|
| Adhesive layer | | Example 1 | Example 2 | Example 3 | Example 4 | Example 5 |
| Binder (A) | A-1 | 60 | 25 | 25 | | 30 |
| | (penetration: 50) | | | | | |
| | A-2 | | | | 25 | |
| | (Shore 00: 40) | | | | | |
| | A-3(Shore 00: 65) | | | | | |
| Reactive filler | B-1 | 40 | 75 | 75 | 75 | 60 |
| (B) | (D50: 8 μm) | | | | | |
| | B-2 | | | | | 15 |
| | (D50: 1 μm) | | | | | |
| | B-3(D50: 1 μm) | | | | | |
| | B-4(D50: 30 μm) | | | | | |

TABLE 2

| | | Present | Present | Present | Present |
|---|---|---|---|---|---|
| Adhesive layer | | Example 6 | Example 7 | Example 8 | Example 9 |
| Binder | A-1 | 50 | 30 | 30 | 25 |
| (A) | (penetration: 50) | | | | |
| | A-2 | | | | |
| | (Shore 00: 40) | | | | |
| | A-3(Shore 00: 65) | | | | |
| Reactive | B-1 | | | | 60 |
| filler | (D50: 8 μm) | | | | |
| (B) | B-2 | | | | |
| | (D50: 1 μm) | | | | |
| | B-3(D50: 1 μm) | 50 | 70 | 70 | 15 |
| | B-4(D50: 30 μm) | | | | |

TABLE 3

| | | Comparative | Comparative | Comparative | Comparative | Comparative |
|---|---|---|---|---|---|---|
| Adhesive layer | | Example 1 | Example 2 | Example 3 | Example 4 | Example 5 |
| Binder | A-1 | 25 | 70 | | 100 | 50 |
| (A) | (penetration: 50) | | | | | |
| | A-2 | — | — | — | — | — |
| | (Shore 00: 40) | | | | | |
| | A-3(Shore 00: 65) | — | — | 50 | — | — |
| Reactive | B-1 | 75 | 30 | 50 | — | — |
| filler | (D50: 8 μm) | | | | | |
| (B) | B-2 | — | — | — | — | — |
| | (D50: 1 μm) | | | | | |
| | B-3(D50: 1 μm) | — | — | — | — | — |
| | B-4(D50: 30 μm) | | | | | 50 |

The materials in Table 1 are as follows.
A-1: Silicone-based resin of penetration 50 (Wacker Silgel 612)
A-2: Silicone-based resin of Shore 00 40 (Wacker Elastosil RT 745 T)
A-3: Silicone-based resin of Shore 00 65 (Elkem EA 8990 SC)
B-1: Aluminum hydroxide (D50=8 μm) (dehydration reaction starting temperature: 200° C.)
B-2: Aluminum hydroxide (D50=1 μm) (dehydration reaction starting temperature: 200° C.)
B-3: Magnesium hydroxide (D50=1 μm) (dehydration reaction starting temperature: 340° C.)
B-4: Zirconium hydroxide (Zirconium (IV) hydroxide) (D50-30 μm) (dehydration reaction starting temperature: 60° C.)

### Evaluation

### Experimental Example 1: Viscosity (cP) of Adhesive Layer Composition

For each of the adhesive compositions of Present Examples and Comparative Examples, viscosity of each adhesive composition was measured using a rheometer (AntonPaar MCR 302e, measuring plate: PP25, and measurement at 25° C.) according to the measurement standard ISO 3219-2 at 25° C., with a shearing speed of 10/sec. Results are listed in Table 4 to Table 6.

### Experimental Example 2: Adhesion (gf/cm)

Samples of the adhesive layers prepared in Present Examples and Comparative Examples were prepared according to the JIS C 6741 standard, and adhesion of the samples was measured while peeling each adhesive layer at a rate of 5 mm per second in an 180° opposite direction. Results are listed in Table 4 to Table 6.

### Experimental Example 3: Heat Resistance of Adhesive Layer

The adhesive layers prepared in Present Examples and Comparative Examples were exposed to 200° C. for 12 hrs, and then the adhesion thereof was measured in the same manner as in Experimental Example 2. Results are listed in Table 4 to Table 6.

### Experimental Example 4: Heat Transfer Delay Test

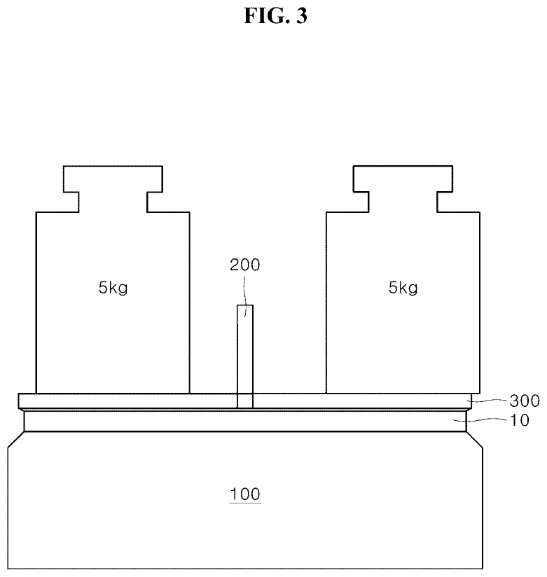

The composite pads 10 of Present Examples and Comparative Examples were cut into a size of 50 mm×50 mm to prepare samples. As illustrated in FIG. 3, the sample 10 was attached to one surface of a hot plate 100 of 650° C. Then, a thermocouple sensor 200 was attached to an opposite surface of the sample opposite to which the hot plate was not attached, and a SUS plate 300 and a 10 kg weight were placed thereon to apply a constant pressure. Using a thermocouple sensor, a duration from a time point of the attachment to the hot plate 100 to a time point at which a central portion of the opposite surface of the composite pad to which the hot plate was not attached reaches 200° C. was measured as a thermal delay duration (sec).

TABLE 4

| Adhesive | Present | Present | Present | Present | Present |
|---|---|---|---|---|---|
| layer | Example 1 | Example 2 | Example 3 | Example 4 | Example 5 |
| Viscosity | 19,500 | 37,600 | 37,600 | 42,800 | 31,200 |
| (cP) | | | | | |
| Adhesion | 105.6 | 111.9 | 111.9 | 270.8 | 123.1 |
| (gf/cm) | | | | | |
| Adhesion | 122.8 | 194.9 | 194.9 | 221.7 | 191.6 |
| (gf/cm) | | | | | |
| after heat | | | | | |
| resistance | | | | | |
| evaluation | | | | | |

TABLE 5

| | Present | Present | Present | Present |
|---|---|---|---|---|
| Adhesive layer | Example 6 | Example 7 | Example 8 | Example 9 |
| Viscosity (cP) | 21,900 | 47,500 | 47,500 | 34,200 |
| Adhesion | 117.1 | 90.9 | 90.9 | 109.3 |
| (gf/cm) | | | | |
| Adhesion | 153.3 | 116.2 | 116.2 | 142.1 |
| (gf/cm) after | | | | |
| heat resistance | | | | |
| evaluation | | | | |

TABLE 6

| | Comparative | Comparative | Comparative | Comparative | Comparative |
|---|---|---|---|---|---|
| Adhesive layer | Example 1 | Example 2 | Example 3 | Example 4 | Example 5 |
| Viscosity (cP) | 37,600 | 11,900 | 21,980 | 1,980 | 13,200 |
| Adhesion | 87.6 | 109.6 | 160.5 | 40.5 | 96.2 |
| (gf/cm) | | | | | |
| Adhesion | 84.4 | 81.23 | 27.3 | 33.5 | 16.8 |
| (gf/cm) after | | | (adhesive | | (adhesive |
| heat resistance | | | surface | | surface |
| evaluation | | | failure) | | failure) |

TABLE 7

| | Present | Present | Present | Present | Present |
|---|---|---|---|---|---|
| Thickness (μm) | Example 1 | Example 2 | Example 3 | Example 4 | Example 5 |
| Silicone foam | 2,000 | 2,000 | 2,000 | 2,000 | 2,000 |
| Adhesive layer | 300 | 50 | 300 | 300 | 300 |
| Outer layer (fire | 100 | 100 | 100 | 100 | 100 |
| resistant layer) | | | | | |

TABLE 8

| | Present | Present | Present | Present |
|---|---|---|---|---|
| Thickness (μm) | Example 6 | Example 7 | Example 8 | Example 9 |
| Silicone foam | 2,000 | 2,000 | 2,000 | 2,000 |
| Adhesive layer | 300 | 50 | 300 | 300 |
| Outer layer (fire | 100 | 100 | 100 | 100 |
| resistant layer) | | | | |

TABLE 9

| | Comparative | Comparative | Comparative | Comparative | Comparative |
|---|---|---|---|---|---|
| Thickness (μm) | Example 1 | Example 2 | Example 3 | Example 4 | Example 5 |
| Silicone foam | 2000 | 2000 | 2000 | 2000 | 2000 |
| Adhesive layer | 25 | 300 | 300 | 300 | 300 |
| Outer layer (fire | 100 | 100 | 100 | 100 | 100 |
| resistant layer) | | | | | |

TABLE 10

| | Present | Present | Present | Present | Present |
|---|---|---|---|---|---|
| | Example 1 | Example 2 | Example 3 | Example 4 | Example 5 |
| Heat transfer | 133 | 116 | 198 | 218 | 225 |
| delay time | | | | | |
| (sec) | | | | | |

TABLE 11

| | Present | Present | Present | Present |
|---|---|---|---|---|
| | Example 6 | Example 7 | Example 8 | Example 9 |
| Heat transfer | 141 | 107 | 184 | 209 |
| delay time | | | | |
| (sec) | | | | |

TABLE 12

| | Comparative | Comparative | Comparative | Comparative | Comparative |
|---|---|---|---|---|---|
| | Example 1 | Example 2 | Example 3 | Example 4 | Example 5 |
| Heat transfer | 40 | 53 | 32 | 16 | 42 |
| delay time | | | | | |
| (sec) | | | | | |

As illustrated in the above tables, the adhesive layers of Present Examples may exhibit the excellent adhesion even when exposed to 200° C. for 12 hours because of the excellent heat resistance thereof. In addition, it was confirmed that the composite pads of Present Examples comprising the adhesive layer delayed the heat transfer with the excellent fire resistance thereof. On the other hand, it was confirmed that Comparative Examples 2 to 5 exhibited reduced adhesion and poor heat transfer delay performance when exposed to 200° C. for 12 hours. In addition, it was confirmed that Comparative Example 1 had poor heat transfer delay performance because of a small thickness of the adhesive layer thereof. In particular, it was confirmed that when exposed to the high temperature for a long time, Comparative Examples 3 and 5 showed the failure and delamination of the adhesive surface.

The composite pad according to embodiments of the invention includes an adhesive layer that exhibits the excellent adhesion between the silicone foam and the outer layer, absorbs heat, and has the fire extinguishing and heat blocking performance. At the same time, the adhesive layer according to an embodiment is capable of preventing the thermal runaway by delaying the heat transfer when exposed to the high temperature.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A composite pad comprising:
a silicone foam; an adhesive layer; and an outer layer,
wherein the adhesive layer comprises a binder and a reactive filler configured to undergo a dehydration reaction at a temperature equal to or higher than 100° C.,
wherein the binder has a hardness in a range of a penetration hardness of 90 to a Shore 00 hardness of 40,
wherein the reactive filler is comprised in an amount of 50 to 300 parts by weight based on 100 parts by weight of the binder, and
wherein a thickness of the adhesive layer is in a range of 40 μm to 400 μm.

2. The composite pad of claim 1, wherein the binder comprises at least one resin selected from a group consisting of a polyurethane-based resin, a silicone-based resin, and an epoxy-based resin.

3. The composite pad of claim 1, wherein a viscosity of the binder is in a range of 100 cP to 2000 cP at 25° C.

4. The composite pad of claim 1, wherein the reactive filler includes metal hydroxide particles.

5. The composite pad of claim 4, wherein the metal hydroxide particles comprise at least one selected from a group consisting of B(OH)₃, Al(OH)₃, Mg(OH)₂, and combinations thereof.

6. The composite pad of claim 1, wherein the reactive filler comprises a mixture of first metal hydroxide particles having a D50 equal to or smaller than 2 μm and second metal hydroxide particles having a D50 equal to or greater than 5 μm.

7. The composite pad of claim 1, wherein the silicone foam comprises a foamed cured product of a composition comprising a polyalkylsiloxane-based resin.

8. The composite pad of claim 1, wherein the outer layer comprises at least one layer selected from a group consisting of a fire resistant layer, a flame retardant layer, an electrically insulating layer, a heat dissipation layer, and combinations thereof.

9. A battery including a plurality of composite pads of claim 1 positioned between battery cells.
